(19) United States
(12) Patent Application Publication
(10) Pub. No.: US 2024/0377699 A1
(43) Pub. Date: Nov. 14, 2024

(54) DYNAMIC DIFFRACTIVE OPTICAL PATTERN GENERATOR

(71) Applicant: Samsung Electronics Co., Ltd., Suwon-si (KR)

(72) Inventors: Haeri Park HANANIA, Sierra Madre, CA (US); Radwanul Hasan SIDDIQUE, Monrovia, CA (US); Yibing Michelle WANG, Temple City, CA (US)

(21) Appl. No.: 18/225,097

(22) Filed: Jul. 21, 2023

Related U.S. Application Data
(60) Provisional application No. 63/465,246, filed on May 9, 2023.
(60) Provisional application No. 63/465,247, filed on May 9, 2023.
(60) Provisional application No. 63/431,617, filed on Dec. 9, 2022.

(51) Int. Cl. G02F 1/29

(52) U.S. Cl. CPC G02F 1/292

(57) ABSTRACT

A diffractive optical pattern generator includes a diffractive optical element layer, and a nanostructure layer configured for beam steering an input light applied to the diffractive optical pattern generator to at least one of a polar beam-steering angle that is measured in a plane that is substantially normal to a direction of the input light and an azimuth beam-steering angle measured with respect to the direction of the input light. A dynamic transmission layer may be included in which at least one region of the dynamic transmission layer may be selectively controllable to transmit light through or to block light from passing through the dynamic transmission layer. The nanostructure layer may include nanostructures having a periodicity ranging from 0.75 λ to 3 λ of a target wavelength λ. The nanostructure layer may be configured to beam steer light input to the DOE layer or beam steer light output from the DOE layer.

### CROSS-REFERENCE TO RELATED APPLICATIONS

This application claims the priority benefit under 35 U.S.C. § 119(c) of U.S. Provisional Patent Application Nos. 63/465,246 and 63/465,247, both filed on May 9, 2023, the disclosures of which are incorporated herein by reference in their entirety. Additionally, this application is related to U.S. Patent Application Ser. No. (Attorney Docket 1535-921).

### TECHNICAL FIELD

The subject matter disclosed herein relates to diffractive optical pattern generators. More particularly, the subject matter disclosed herein relates to diffractive optical pattern generators capable of beam steering and/or dynamic diffraction patent generation.

### BACKGROUND

Diffractive optical elements (DOEs) generate desired optical patterns by controlling diffraction of light. DOEs may be used in combination with a vertical-cavity surface emitting laser (VCSEL) for 3D sensing (ADAS, AR/VR, healthcare, security, etc.), and for optical sensing (microfluidics and other photonic sensors, etc.). Commercial DOEs may include multiple levels and complex microscale designs, and may be formed from polymers, which are not compatable with complementary metal-oxide semiconductor (CMOS) fabrication techniques.

FIG. 1 depicts an example Diffractive Optical Element (DOE) 100 that generates a light diffraction pattern. Conventional DOEs may also be called gratings or diffraction gratings. As depicted in FIG. 1, light 101 that is output from a laser source and having a target wavelength λ is incident on the DOE 100. As the light 101 passes through the DOE 100, the DOE 100 generates a light diffraction pattern 102. Several example light diffraction patterns having lines and/or dots are depicted at 103. Light diffraction patterns that may be generated by DOEs are not limited to the example diffraction patterns depicted at 103.

A conventional DOE has a microscale periodicity that is greater than 10 times a target wavelength (>10 λ) and has a structure that typically has multiple different heights. A conventional DOE design also tends to be complex and involves multiple fabrication steps. Conventional DOEs are formed from polymers, which makes fabrication of a conventional DOE incompatible with CMOS fabrication techniques.

Another class of DOEs, commonly called metasurfaces, have a microscale periodicity that is on the order of one-half of the target wavelength (˜λ/2). This class of DOEs are used to absorb, reflect, deflect and/or focus light (both near-and far-field) at a target wavelength λ. This class of DOEs typically have low transmission efficiency and have a complex design.

### SUMMARY

An example embodiment provides a diffractive optical pattern generator that may include a diffractive optical element layer, and a nanostructure layer configured for beam steering an input light applied to the diffractive optical pattern generator to at least one of a predetermined polar beam-steering angle that is measured in a plane that is substantially normal to a direction of the input light and a predetermined azimuth beam-steering angle measured with respect to the direction of the input light. In one embodiment, the nanostructure layer may include pillar-shaped nanostructures formed on a surface of a substrate layer, holes formed in the substrate layer, or a combination thereof. In another embodiment, the nanostructure layer may include nanostructures having a predetermined periodicity ranging from 0.75 λ to 3 λ of a target wavelength λ. In still another embodiment, the diffractive optical pattern generator may further include a dynamic transmission layer that may include at least one region of the dynamic transmission layer that is selectively controllable to transmit light through or to block light from passing through the dynamic transmission layer. In yet another embodiment, the dynamic transmission layer may include at least one of indium-tin oxide, a liquid-crystal material, a phase-changing material, an organic metal, and a semiconductor material. In one embodiment, the nanostructure layer may include a first region and a second region in which the first region of the nanostructure layer may include a first predetermined polar beam-steering angle and a first predetermined azimuth beam-steering angle with respect to the input light, and the second region of the nanostructure layer, and the dynamic transmission layer may include a first region and a second region that respectively correspond to the first region and the second region of the nanostructure layer in which the first region and the second region of the dynamic transmission layer each may be selectively controllable to transmit light through or to block light from passing through the first and second regions of the dynamic transmission layer to generate different diffractive optical patterns. In another embodiment, the nanostructure layer may be configured to beam steer light input to the DOE layer or beam steer light output from the DOE layer. In still another embodiment, the DOE layer may generate a n×n diffraction pattern in which n comprises an integer greater than 0, and the nanostructure layer may include a n×n arrangement of cell regions in which each cell region may include at least one of a corresponding polar beam-steering angle and a corresponding azimuth beam-steering angle. In still another embodiment, n=3, and the 3×3 arrangement of cell regions may include a center cell region, four corner cell regions, and four edge cell regions in which cach edge cell region may be located between a corner edge region, cach edge cell region may include an azimuth beam-steering angle equal to one c=⅓ (field of view of the DOE layer), and each corner cell region may include an azimuth beam-steering angle equal to \sqrt{2}c.

An example embodiment provides a diffractive optical pattern generator that may include a diffractive optical element layer, a nanostructure layer configured to collimate light or diffuse light, and a dynamic transmission layer that may include at least one region of the dynamic transmission layer that is selectively controllable to transmit light through or to block light from passing through the dynamic transmission layer. In one embodiment, the nanostructure layer may include pillar-shaped nanostructures formed on a surface of a substrate layer, holes formed in the substrate layer, or a combination thereof. In another embodiment, the nanostructure layer may be configured for beam steering an input light applied to the diffractive optical pattern generator to at least one of a predetermined polar beam-steering angle that is measured in a plane that is substantially normal to a direction of the input light and a predetermined azimuth beam-steering angle measured with respect to the direction of the input light. In still another embodiment, the nanostructure layer may include nanostructures having a predetermined periodicity ranging from 0.75 λ to 3 λ of a target wavelength λ. In yet another embodiment, the dynamic transmission layer may include at least one of indium-tin oxide, a liquid-crystal material, a phase-changing material, an organic metal, and a semiconductor material. In one embodiment, the nanostructure layer may include a first region and a second region in which the first region of the nanostructure layer may include a first predetermined polar beam-steering angle and a first predetermined azimuth beam-steering angle with respect to an input light, and the second region of the nanostructure layer, and the dynamic transmission layer may include a first region and a second region that respectively correspond to the first region and the second region of the nanostructure layer in which the first region and the second region of the dynamic transmission layer may each be selectively controllable to transmit light through or to block light from passing through the first and second regions of the dynamic transmission layer to generate different diffractive optical patterns. In another embodiment, the diffractive optical element layer may generate a n×n diffraction pattern in which n comprises an integer greater than 0, and the nanostructure layer may include a n×n arrangement of cell regions in which each cell region may include at least one of a corresponding polar beam-steering angle and a corresponding azimuth beam-steering angle. In still another embodiment, n=3, and the 3×3 arrangement of cell regions may include a center cell region, four corner cell regions, and four edge cell regions in which each edge cell region may be located between a corner edge region, cach edge cell region may include an azimuth beam-steering angle equal to one c=⅓ (field of view of the DOE layer), and each corner cell region may include an azimuth beam-steering angle equal to \sqrt{2}c.

An example embodiment provides a diffractive optical pattern generator that may include a diffractive optical element layer that may generate a n×n diffraction pattern in which n may include an integer greater than 0, a nanostructure layer that may include a n×n arrangement of cell regions in which each cell region may include at least one of a corresponding polar beam-steering angle that is measured in a plane that is substantially normal to a direction of the input light and a corresponding azimuth beam-steering angle measured with respect to the direction of the input light, and a dynamic transmission layer that may include at least one region of the dynamic transmission layer that may be selectively controllable to transmit light through or to block light from passing through the dynamic transmission layer. In one embodiment, n=3, and the 3×3 arrangement of cell regions may include a center cell region, four corner cell regions, and four edge cell regions in which each edge cell region may be located between a corner edge region, cach edge cell region may include an azimuth beam-steering angle equal to one c=⅓ (field of view of the DOE layer), and cach corner cell region may include an azimuth beam-steering angle equal to \sqrt{2}c. In another embodiment, the nanostructure layer may be configured for beam steering an input light applied to the diffractive optical pattern generator to at least one of a predetermined polar beam-steering angle with respect to the input light and a predetermined azimuth beam-steering angle with respect to the input light, the nanostructure layer may include nanostructures having a predetermined periodicity ranging from 0.75 λ to 3 λ of a target wavelength λ, and the nanostructure layer may be configured to beam steer light input to the DOE layer or beam steer light output from the DOE layer.

### BRIEF DESCRIPTION OF THE DRAWING

In the following section, the aspects of the subject matter disclosed herein will be described with reference to exemplary embodiments illustrated in the figure, in which:

FIG. 1 depicts an example diffractive optical element that generates a light diffraction pattern;

FIG. 2A depicts a plan view of an example embodiment of a DOE according to the subject matter disclosed herein;

FIGS. 2B-2D depict cross-sectional side views of three example embodiments of the DOE depicted in FIG. 2A;

FIG. 3A depicts a cross-sectional side view of an example embodiment of a DOE that includes a metasurface configured as a collimator and associated diffraction light patterns according to the subject matter disclosed herein;

FIG. 3B depicts a cross-sectional side view of an example embodiment of a DOE that includes a metasurface configured as a collimator and as a diffuser and an associated diffraction light pattern according to the subject matter disclosed herein;

FIGS. 4A-4C respectively depict cross-sectional side views of example embodiments of DOEs that generate dynamic diffractive optical patterns according to the subject matter disclosed herein;

FIG. 4D depicts an example diffraction light pattern that may be generated by the DOE in FIG. 4A when all locations of the transparent conductive material layer are selected to transmit (turned on) an input light;

FIG. 4E depicts an example diffraction light pattern that may be generated by the DOE in FIG. 4A when some locations of the layer transparent conductive layer are selected to transmit (turned on) an input light and some locations are selected to reflect (turned off) the input light.

FIG. 5A shows a polar angle/azimuth angle coordinate system;

FIG. 5B depicts a cross-sectional side view of an example embodiment of a DOE that is not configured for beam steering according to the subject matter disclosed herein;

FIG. 5C depicts a cross-sectional side view of an example embodiment of a DOE that is configured for beam steering according to the subject matter disclosed herein;

FIG. 6A relates to an example DOE that is not configured for beam steering according to the subject matter disclosed herein;

FIG. 6B relates to an example DOE that is configured for beam steering according ot the subject matter disclosed herein;

FIG. 6C relates to an example DOE that is configured for beam steering according ot the subject matter disclosed herein;

FIG. 6D relates to an example DOE that is configured for beam steering according ot the subject matter disclosed herein;

FIG. 7A depicts a cross-sectional side view of a DOE that includes a metasurface that generates seamless tiling patterns for fan-out without using a VCSEL array according to the subject matter disclosed herein;

FIG. 7B depicts polar and azimumth angles configured for different cell regions of a metasurface of the DOE of FIG. 7A according to the subject matter disclosed herein;

FIG. 7C depicts an example diffraction pattern generated by the DOE of FIG. 7A;

FIG. 8A depicts a cross-sectional side view of a DOE that generates dynamic optical patterns according to the subject matter disclosed herein;

FIG. 8B depicts how a metasurface has been arranged into four cell regions in which each cell region has a different polar and azimuth steering angles;

FIG. 8C depicts an example in which the two right-most cell regions of the metasurface of FIG. 8B are controlled to turn off light dots contributed to the diffraction pattern by the two cell regions;

FIG. 8D depicts another example in which two diagonal cell regions (lower left and upper right) of the metasurface of FIG. 8B are controlled to turn off light dots contributed to the diffraction pattern by the two “off” cell regions;

FIG. 9A is a graph of transmission efficiency and of field of view (FOV) as a function of lattice constant scaled to λ according to the subject matter disclosed herein;

FIGS. 9B-9D are example diffraction patterns for different lattice constants according to the subject matter disclosed herein;

FIGS. 10A and 10B respectively depict a sideview and a plan view of an example metasurface cell that is configured to provide a beam steering angle of 6° at a target wavelength of 905 nm according to the subject matter disclosed herein;

FIG. 10C is an example diffraction pattern that is generated by the metasurface of FIG. 10A;

FIG. 11A depicts a side view of an example DOA that is configured to provide a 3×3 light dot pattern having a beam steering angle of 8° at a target wavelength of 905 nm according to the subject matter disclosed herein;

FIG. 11B depicts a top view of a metasurface layer that is configured to provide the beam steering angle of 8° at the target wavelength of 905 nm according to the subject matter disclosed herein;

FIGS. 11C and 11D respectively are 3×3 transverse electric (TE) mode and transverse magnetic (TM) mode light diffraction patterns for the example DOE of FIG. 11A; and

FIG. 12 depicts an electronic device that may include a DOE capable of beam steering and/or dynamic diffraction pattern generation according to the subject matter disclosed herein.

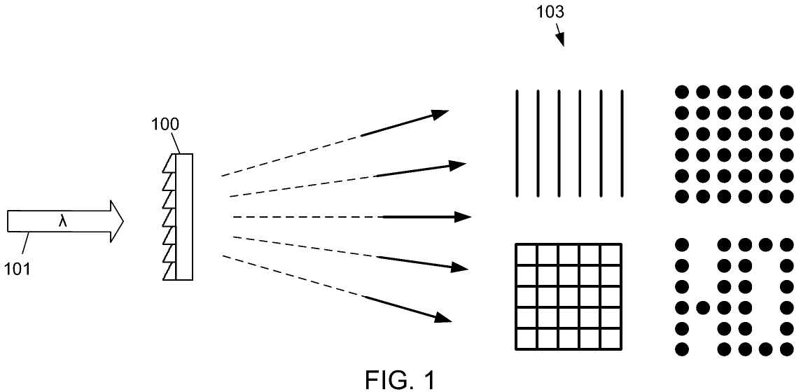

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising.” when used in this specification, specify the presence of stated features, integers, steps, operations, elements, and/or components, but do not preclude the presence or addition of one or more other features, integers, steps, operations, elements, components, and/or groups thereof. The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed hercin.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

The subject matter disclosed herein provides a diffractive optical pattern generator having a DOE layer and a phase-modulating thin-film metasurface layer that may be configured to modulate either the input to or the output from the DOE layer. That is, the phase-modulating thin-film metasurface layer may be integrated underneath or on top of a DOE layer to enable modulation of the input to or the output from the DOE layer. The DOE layer may include nano-micro scale pillars that provide an optical fan-out, and metasurface layer may include nanoscale pillars that may provide at least one of, but not limited to, beam steering, collimation, and diffusion. The DOE layer and the metasurface layer may be made from either a polymer or a CMOS-compatible material. An anti-reflection coating may be included as part of the diffractive optical pattern generator to further improve efficiency.

The subject matter disclosed herein also provides a diffractive optical pattern generator that may dynamically generate optical patterns. In one embodiment, a diffractive optical pattern generator includes a dynamic transmission layer that enables generation of customized optical patterns by switching on/off desired parts of the optical pattern. The dynamic transmission layer may be formed from, for example, indium tin oxide, liquid crystal, phase changing materials, organic metals, and/or semiconductors. In one embodiment, a diffractive optical pattern generator includes a phase-modulating metasurface integrated in combination with a dynamic transmission layer that enables dynamic steering of a projection angle of an optical pattern. Either of the DOE layer or the phase-modulating metasurface layer may be integrated with an encapsulation layer made of the dynamic transparent conductive material. In one embodiment, the dynamic transparent conductive material may be a separate layer. Accordingly, a diffractive optical pattern generator disclosed herein may generate an unlimited number of optical patterns and may be programmed to be self-adaptive to various scenes, which may save power and time constraints associated with data processing because being able to dynamically control where light patterns are projected may be critical for more prompt detection of objects that may be of more relative interest by reducing associated time/power aspects for data processing (which also reduces system cost).

In one embodiment, a diffractive optical pattern generator disclosed herein provides a DOE layer and a phase-modulating thin-film metasurface layer that may be integrated directly on a single-light source or on an array of light sources, such as a VCSEL array, thereby providing a system having a total track length of a few microns.

In one embodiment, the metasurface layer may be divided into a number of cells and each cell may be optimized for a selected predetermined polar angle and a predetermined azimuth angle to generate a desired pattern.

One example embodiment provides a multi-layer structure that may include a DOE layer, and a phase-modulating metasurface layer in which the metasurface layer includes nanoscale cells. The nanoscale cells may be configured for at least one of, but not limited to, beam steering, collimate light, or diffuse light. The DOE layer may include nano-micro scale pillars. In one embodiment, the DOE layer may include pillars and/or holes. In another embodiment, the diffractive layer or phase-modulating layer may be encapsulated or stacked with a transparent conducting material that dynamically blocks or transmits light. In still another embodiment, the phase-modulating layer may be optimized for beam steering of input light source at desired polar and azimuth angles. In one embodiment, the phase-modulating layer may be configured to generate uniform tiles laser dots by setting the steering azimuth angle at (field of view of the DOE)/3.

In one embodiment, the subject matter disclosed herein provides a diffractive optical pattern generator that includes a DOE layer and a metasurface layer having a periodicity and a size of nanostructures that are comparable to or smaller than a target light wavelength (i.e., 0.75 λ to 3 λ), which makes the metasurface of nanoscale size. In one embodiment, the DOE layer may be formed as a single layer; and may has a periodic structure that may be designed for a target field of view. The metasurface layer may include nanostructures that, depending upon the application, may have arbitrarily shaped geometries and may have rounded corners of radius. The corners of radius may be optimized for transmission efficiency and for nonuniformity of light-dot intensity for a resulting diffraction pattern. Alternatively, and again depending upon the application, the nanostructures may be designed to have substantially square corners.

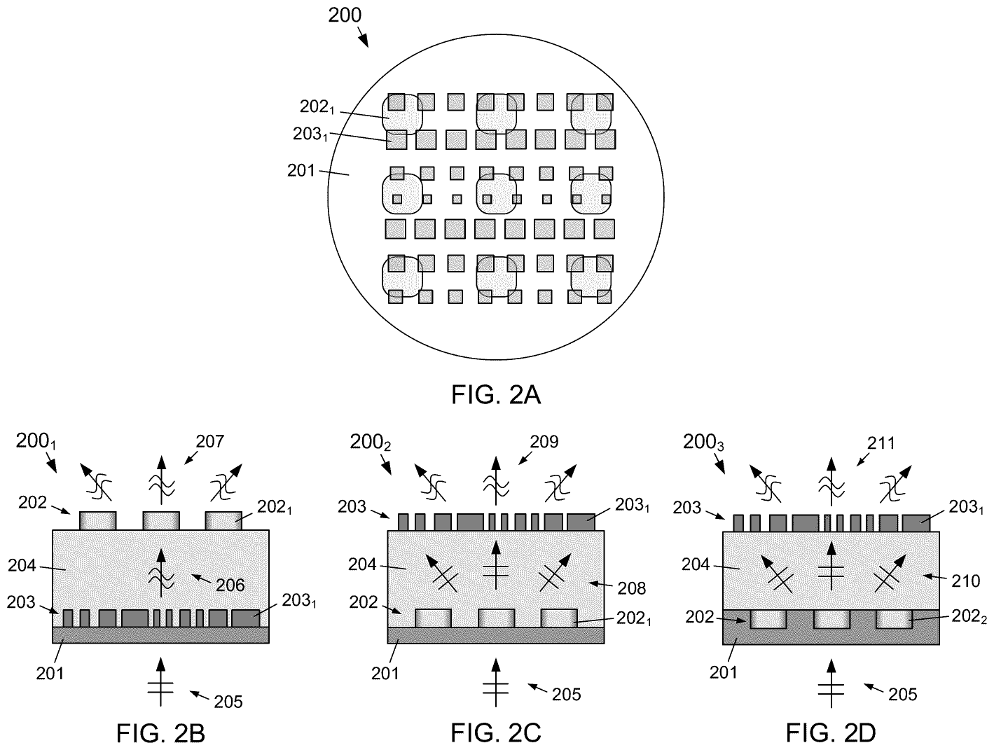

FIG. 2A depicts a plan view of an example embodiment of a DOE 200 according to the subject matter disclosed herein. FIGS. 2B-2D depict cross-sectional side views of three example embodiments of the DOE 200 depicted in FIG. 2A. All three embodiments of the DOE 200 may include a substrate layer 201, a DOE layer 202, and a thin-film metasurface layer 203. An encapulation layer 204 may be formed between the DOE layer 202 and the metasurface layer 203. The DOE layer 202 may generate patterns of light dots by diffracting an optical input, and the metasurface 203 may modulate the phase of the optical input by guiding light.

The DOE layer 202 may include pillars 202₁ and/or holes 202₂. The pillars 202₁ may be formed from silicon nitride (SiN). The metasurface layer 203 may include an array of nanostructures 203₁, and may be formed from amorphous silicon (aSi). The encapsulation layer 204 may be formed from SiO₂. An anti-reflective coating (not shown) may be formed on the surface of the DOE 200, and in one embodiment may be formed from multiple layers of anti-reflective coating materials.

The arrangement of the DOE layer 202 and the metasurface layer 203 with respect to a light source may vary between different embodiments, which is why the pillars 202₁ and the nanostructured 203₁ appear to be transparent in the plan view of FIG. 2A. The different arrangement variations provide (1) phase modulation of the input to the DOE layer 202, or (2) phase modulation of the output of the DOE layer 202.

The DOE 200₁ depicted in FIG. 2B is an example embodiment that is configured to phase modulate the input to the DOE layer 202. More specifically, the DOE 200₁ is configured with a metasurface layer 203 that is formed on the substrate layer 201. The DOE 200₁ includes an encapsulation layer 204 that is formed on the metasurface layer 203, and the DOE layer 202 is formed on the encapsulation layer 204 distal from the substrate layer 201. The DOE layer 202 includes pillars 202₁. An input light 205 from, for example, a laser source, is applied to a side of the substrate layer 201 that is distal from the DOE layer 202. The input light 205 is depicted by an arrow having two transverse straight lines to represent unmodulated light. The input light 205 is phase modulated by the metasurface layer 203 forming modulated light 206, as indicated by an arrow having two transverse sinewave-shaped lines to represent phase-modulated light. The phase-modulated light 206 is diffracted by the DOE layer 202 forming a modulated and diffracted light pattern 207, as indicated by diverging arrows that each have transverse sinewave-shaped lines.

The DOE 200₂ depicted in FIG. 2C is an example embodiment that is configured to modulate the output from the DOE layer 202. The DOE 200₂ is configured with a DOE layer 202 that is formed on the substrate layer 201. The DOE layer 202 includes pillars 202₁. In an alternative embodiment, the DOE layer 202 may also include holes (not shown in FIG. 2C) formed in the substrate layer 201. The embodiment of DOE 200₂ also includes an encapsulation layer 204 that is formed on the DOE layer 202, and the metasurface layer 203 is formed on the encapsulation layer 204 distal from the substrate layer 201. An unmodulated input light 205 from, for example, a laser source, is applied to a side of the substrate layer 201 that is distal from the metasurface layer 203. The input light 205 is diffracted by the DOE layer 202 forming a unmodulated diffracted light pattern 208. The diffracted light 208 is phase modulated by the metasuface layer 203 forming a modulated diffracted light pattern 209.

The DOE 2003 depicted in FIG. 2D is an example embodiment that is configured to modulate the output from the DOE layer 202. The DOE 200₂ is configured with a DOE layer 202 that is formed on the substrate layer 201. The DOE layer 202 includes holes (or cavities) 202₂ formed in the substrate layer 201. In an alternative embodiment, the DOE layer 202 may also include pillars (not shown in FIG. 2D) that are formed on the substrate layer 201. The embodiment of DOE 200₃ includes an encapsulation layer 204 that is formed on the DOE layer 202, and the metasurface layer 203 is formed on the encapsulation layer 204 distal from the substrate layer 201. An unmodulated input light 205 from, for example, a laser source, is applied to a side of the substrate layer 201 that is distal from the metasurface layer 203. The input light 205 is diffracted by the DOE layer 202 forming a unmodulated diffracted light pattern 210. The diffracted light 210 is phase modulated by the metasuface layer 203 forming a modulated diffracted light pattern 211.

The pillars 202₁ may be formed from a CMOS-compatible material, such as silicon nitride, having a refractive index that is greater than the refractive index of the substrate 201. The holes 202₂ may have a refractive index that is lower than the refractive index of the substrate 201. A nanostructure having pillars 202₁ may be used in combination with holes 202₂ when a DOE is desired to generate different diffractive patterns or a pattern having different light-dot intensities in different regions of the pattern. As used herein, the term “pillar” may be used interchangeably with the term “hole”. The geometry (i.e., the plan-view cross-sectional shape) of the pillars 202₁ and the holes 202₂ may be a circle, an ellipse, a square, a rectangle, or any other geometry resembling a circle, an ellipse, a square, or a rectangle; or a combination thereof in order to generate a desired optical pattern. Further, the geometry of the pillars 202₁ and the holes 202₂ may be with or without rounded corners. The rounded corners may have a selected radius that provides a transmission efficiency and/or a light-dot nonuniformity for a desired optical pattern.

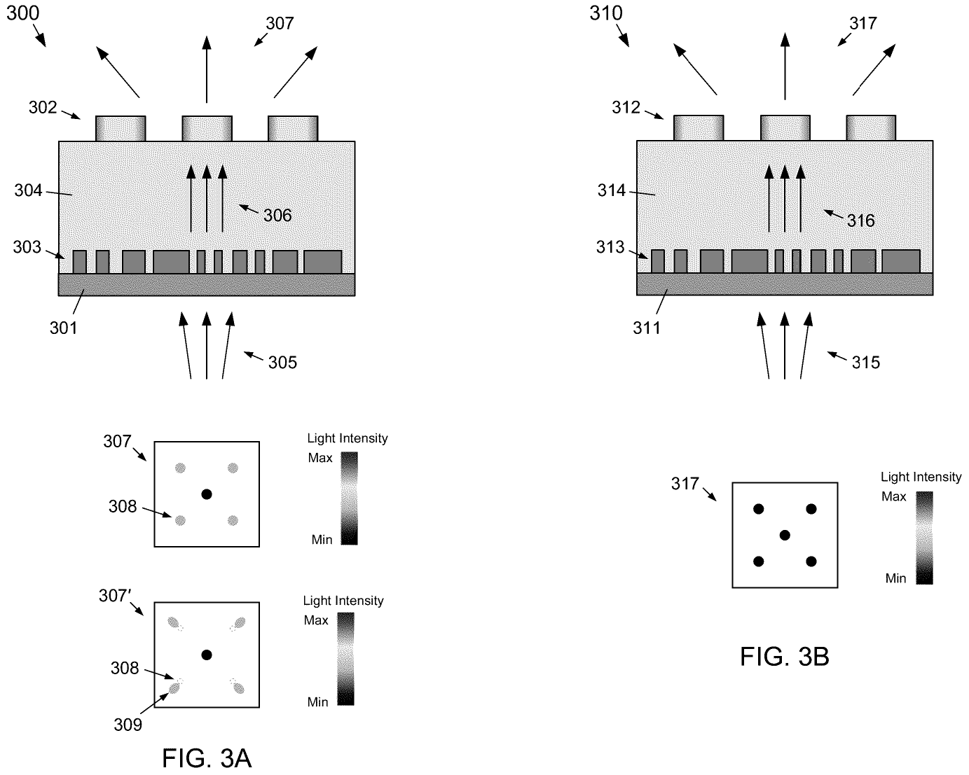

The top image of FIG. 3A depicts a cross-sectional side view of an example embodiment of a DOE 300 that includes a metasurface configured as a collimator according to the subject matter disclosed herein. The DOE 300 may include a substrate layer 301, a DOE layer 302, and a metasurface layer 303. An encapulation layer 304 may be formed between the DOE layer 302 and the metasurface layer 303. An input light 305 from, for example, a laser source, is applied to a side of the substrate layer 301 that is distal from the DOE layer 302. The input light 305 is depicted by diverging arrows to represent that the input light is uncollimated. The metasuface layer 303 collimates the input light 305 to form collimated light 306, which is represented by three parallel arrows. The collimated light 306 is diffracted by the DOE layer 302 forming a diffracted light pattern 307, as indicated by diverging arrows.

The middle image of FIG. 3A depicts the diffracted light pattern 307 that has been generated by the DOE 300 in which the metasurface layer 303 has been configured as a collimator. The generated light pattern 307 is a five light-dot pattern in which the center light dot of the pattern has a greater intensity than the four other light dots of the pattern. The light pattern 307′ depicted at the bottom of FIG. 3A is a diffracted light pattern that would have been generated by the DOE 300 if the metasurface 303 had been omitted. The light pattern 307′ depicts the expected locations 308 of the four outside light dots, indicated by dashed circles in the light pattern 307′, as shifted to diverging locations 309 if the metasurface 303 had been omitted.

The top image of FIG. 3B depicts a cross-sectional side view of an example embodiment of a DOE 310 that includes a metasurface configured as a collimator and as a diffuser according to the subject matter disclosed herein. The DOE 310 may include a substrate layer 311, a DOE layer 312, and a metasurface layer 313. An encapulation layer 314 may be formed between the DOE layer 312 and the metasurface layer 313. An uncollimated and diverging input light 315 from, for example, a laser source, is applied to a side of the substrate layer 311 that is distal from the DOE layer 312. The metasuface layer 313 collimates and diffuses the input light 315 to form collimated and diffused light 316. The collimated and diffused light 316 is diffracted by the DOE layer 312 forming a diffracted light pattern 317.

The bottom image in FIG. 3B depicts the diffracted light pattern 317 that has been generated by the DOE 310 in which the metasurface layer 313 has been configured as a collimator and as a diffuser. The generated light pattern 317 is a five light-dot pattern in which the light dots of the pattern all have about the same intensity because the diffusing aspect of the metasurface layer 313 spreads the light intensity equally, which enables a uniform power for each light dot. If the diffusing aspect is omitted from the metasurface 313, the generated pattern would appear like pattern 307 in the middle image of FIG. 3A.

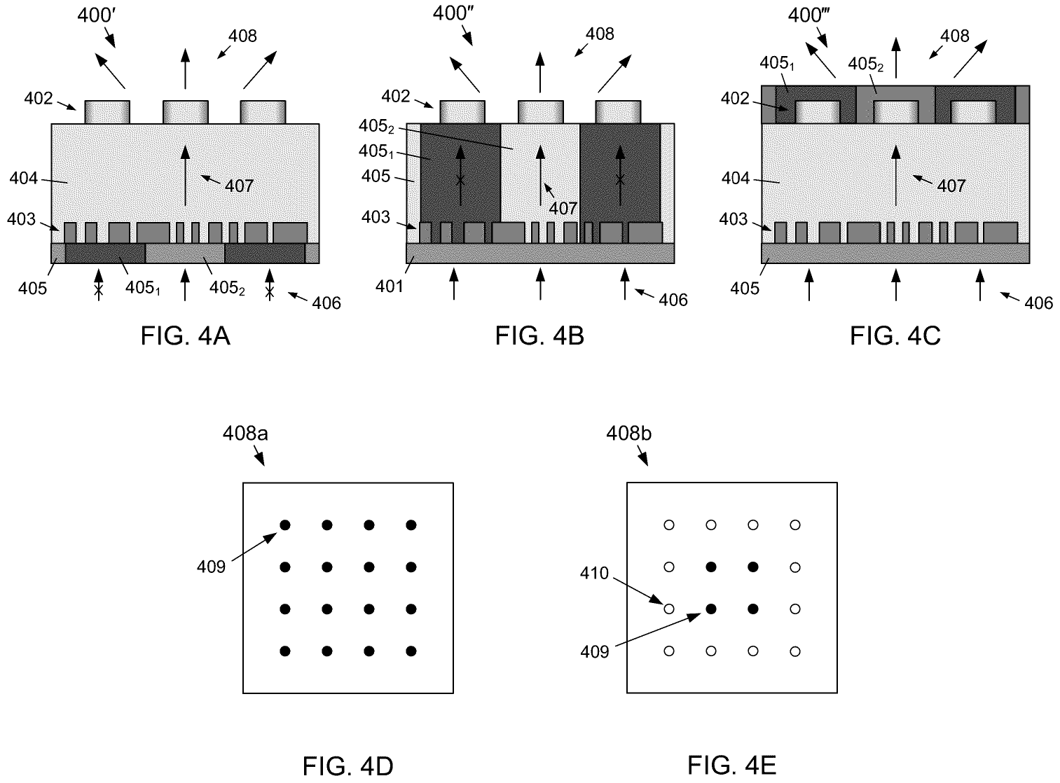

FIGS. 4A-4C respectively depict cross-sectional side views of example embodiments of DOEs 400 that generate dynamic diffractive optical patterns according to the subject matter disclosed herein. That is, cach of DOEs 400 are configured so that dots of a diffraction pattern at locations of interest may be selectively switched on (or off) in order to save power/or and processing time associated with data processing. Each of the DOEs 400 may include a substrate layer 401, a DOE layer 402, and a metasurface layer 403. Some embodiments may include an encapulation layer 404 that may be formed between the DOE layer 402 and the metasurface layer 403. Each of DOEs 400 includes a transparent conductive material 405 that may be dynamically light transmitting or reflecting, such as indium tin oxide (ITO), liquid crystal, phase-changing materials, organic metals, and/or semiconductors. The transparent conducting material 405 may be integrated as a layer itself, or as a capping material for the DOE layer 402 or for the metasurface layer 403.

FIG. 4A depicts a cross-sectional side view of a first example embodiment of a DOE 400′ that generates a dynamic diffractive optical pattern according to the subject matter disclosed herein. The DOE 400′ may include a transparent conductive material layer 405 that is formed as a separate layer and a metasurface layer 403 may be formed on the layer 405. An encapulation layer 404 may be formed between the DOE layer 402 and the metasurface layer 403.

The transparent conductive material layer 405 may include regions 405₁ that may be selectively controlled to be light transmitting or light reflecting, and regions 405₂ that are always light transmitting (or always light reflecting). Input light 406 is either selectively transmitted through or reflected by the layer 405 at regions 405₁. Reflected input light is represented by arrows having a superimposed X. The metasurface layer 403 phase modulates the light 407 that is transmitted through the layer 405, and the DOE layer 402 generates a diffraction light pattern 408.

FIG. 4D depicts an example diffraction light pattern 408a that may be generated by the DOE 400′ when all locations 409 of the layer 405 are selected to transmit (turned on) the input light 406. FIG. 4E depicts an example diffraction light pattern 408b that may be generated by the DOE 400′ when some locations 409 of the layer 405 are selected to transmit (turned on) the input light 406 and some locations 410 are selected to reflect (turned off) the input light 406.

FIG. 4B depicts a cross-sectional side view of a second example embodiment of a DOE 400″ that generates a dynamic diffractive optical pattern according to the subject matter disclosed herein. A transparent conductive material layer 405 may be formed between the DOE layer 402 and the metasurface layer 403. The DOE 400″ may operate in a similar manner as DOE 400′ of FIG. 4A. The example diffraction light patterns 408a and 408b of FIGS. 4D and 4E may be generated by the DOE 400″.

FIG. 4C depicts a cross-sectional side view of a third example embodiment of a DOE 400″′ that generates a dynamic diffractive optical pattern according to the subject matter disclosed herein. A transparent conductive material layer 405 may be formed directly on the DOE layer 402. The DOE 400″′ may operate in a similar manner as the DOE 400′ of FIG. 4A. The example diffraction light patterns 408a and 408b of FIGS. 4D and 4E may be generated by the DOE 400″′.

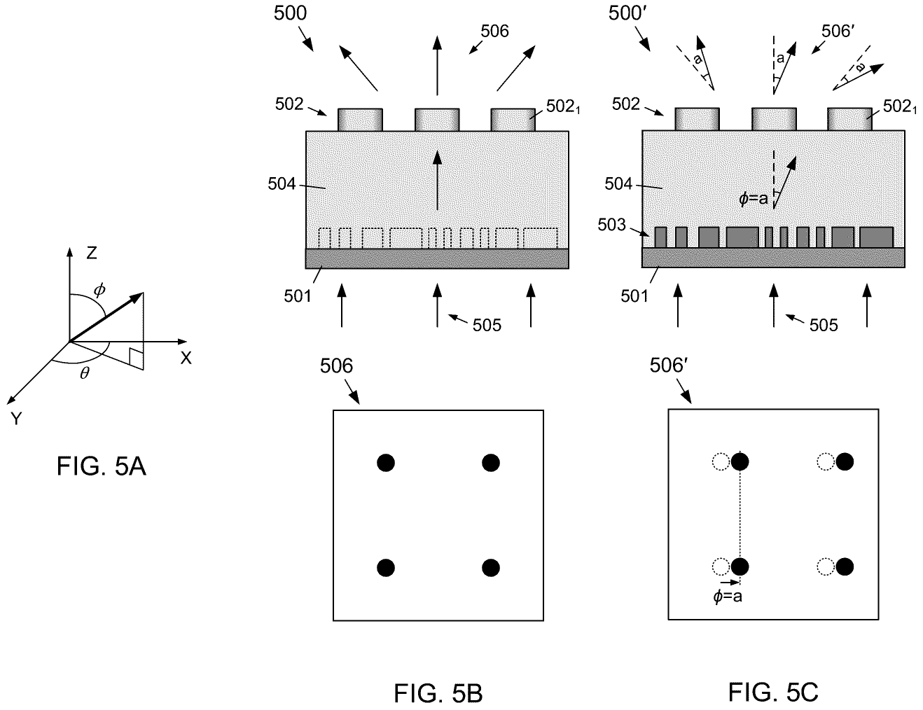

In addition to being capable of generating dynamic diffraction optical patterns, a DOE disclosed herein is also capable of beam steering. That is, a metasurface of a DOE according to the subject matter disclosed herein may be configured to steer an input beam to a selected polar angle θ and/or a selected azimuth angle ϕ. FIG. 5A shows a polar angle/azimuth angle coordinate system. The polar angle θ is measured in the XY plane of the coordinate system, and the azimuth angle ϕ is measured in the XZ plane of the coordinate system.

FIG. 5B depicts a cross-sectional side view of an example embodiment of a DOE 500 that is not configured for beam steering according to the subject matter disclosed herein. The DOE 500 may include a substrate layer 501 and a DOE layer 502. The DOE 500 does not include a metasurface (which is depicted as a metasurface having dashed outlines). An encapulation layer 504 may be formed between the DOE layer 502 and the substrate layer 501. The DOE layer 502 may include pillars 502₁ and/or holes (not shown). An input light 505 from, for example, a laser source, is applied to a side of the substrate layer 501 that is distal from the DOE layer 502. An example diffraction pattern 506 generated by the DOE layer 502 is depicted below the cross-sectional side view of the DOE 500.

FIG. 5C depicts a cross-sectional side view of an example embodiment of a DOE 500′ that is configured for beam steering according to the subject matter disclosed herein. The DOE 500′ may include a substrate layer 501, a DOE layer 502, and a metasurface layer 503 that has been configured for beam steering. An encapulation layer 504 may be formed between the DOE layer 502 and the metasurface layer 503. The DOE layer 502 may include pillars 502₁ and/or holes (not shown). An input light 505 from, for example, a laser source, is applied to a side of the substrate layer 501 that is distal from the DOE layer 502. An example diffraction pattern 506′ generated by the DOE layer 502 and the metasurface layer 503 is depicted below the cross-sectional side view of the DOE 500′.

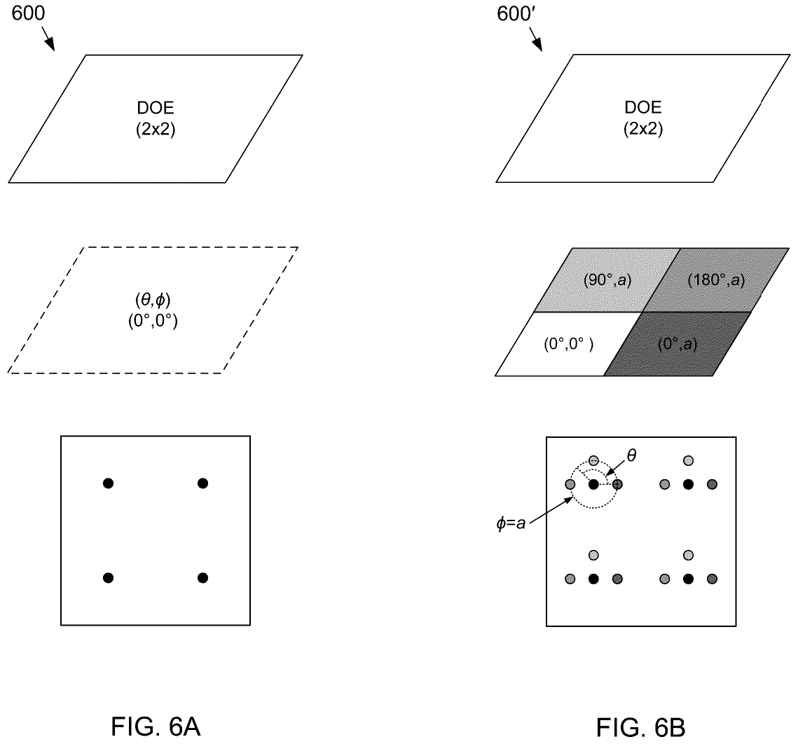

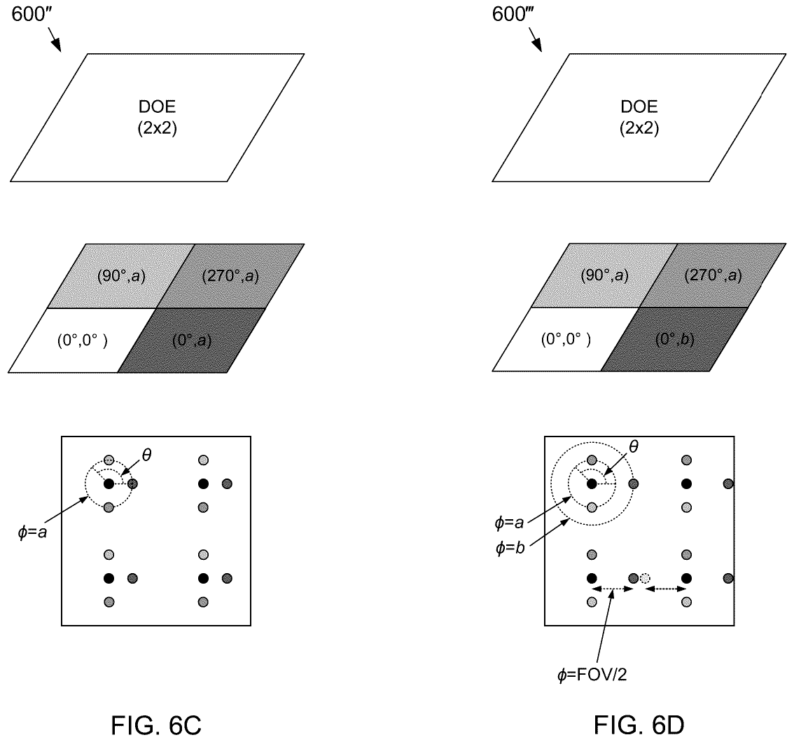

FIG. 6A relates to an example DOE 600 that is not configured for beam steering according to the subject matter disclosed herein. The DOE 600 may generate an example 2×2 diffraction pattern and may be considered to correspond to the DOE 500 of FIG. 5B. The top image of FIG. 6A indicates that the DOE 600 is configured to generate a 2×2 diffraction pattern. The dashed lines of the middle image of FIG. 6A indicates that the DOE 600 does not include a phase-modulating metasurface. The bottom image of FIG. 6A is the diffraction pattern generated by the DOE 600.

FIG. 6B relates to an example DOE 600′ that is configured for beam steering according ot the subject matter disclosed herein. The top image of FIG. 6B indicates that the DOE 600′ is configured to generate a 2×2 diffraction pattern. The middle image of FIG. 6B indicates that the metasurface of the DOE 600′ is configured into four regions, cach having a different fill shade ranging from white to a relatively dark gray. The white metasurface region has been configured for a polar angle θ=0° and an azimuth angle ϕ=0°. In one embodiment, the white metasurface region may be considered to not have a phase-modulating metasurface structure. Alternatively, the white metasurface region be configured with nanostructures configured for a polar angle θ=0° and an azimuth angle ϕ=0°. One region (upper left) of the metasurface of the DOE 600′ may be configured for a polar angle θ=90° and an azimuth angle ϕ=a. Another region (upper right) of the DOE 600′ may be configured for a polar angle of θ=180° and an azimuth angle ϕ=a. The fourth region (lower right) of the DOE 600′ may be configured for a polar angle of θ=0° and an azimuth angle ϕ=a.

The bottom image of FIG. 6B depicts an example diffraction pattern that is generated by the DOE 600′. The diffraction pattern includes four groups of light dots in which each group of light dots includes four light dots. The center light dot in each group corresponds to the region of the metasurface configured for a (0°,0°) steering beam. The light dot at (90°,a) in each group corresponds to the region of the metasurface configured for a (90°,a). The light dot at (180°,a) in each group corresponds to the region of the metasurface configured for a (180°,a). The light dot at (0°,a) in each group corresponds to the region of the metasurface configured for a (0°,a).

FIG. 6C relates to an example DOE 600″ that is configured for beam steering according ot the subject matter disclosed herein. The top image of FIG. 6C indicates that the DOE 600″ generates a 2×2 diffraction pattern. The middle image of FIG. 6C indicates that the metasurface of the DOE 600″ is configured into four regions, each having a different fill shade ranging from white to a relatively dark gray. The white metasurface region has been configured for a polar angle θ=0° and an azimuth angle ϕ=0°. One region (upper left) of the metasurface of the DOE 600″ may be configured for a polar angle θ=90° and an azimuth angle ϕ=a. Another region (upper right) of the DOE 600″ may be configured for a polar angle of θ=270° and an azimuth angle ϕ=a. The fourth region (lower right) of the DOE 600″ may be configured for a polar angle of θ=0° and an azimuth angle ϕ=a.

The bottom image of FIG. 6C depicts an example diffraction pattern that is generated by the DOE 600″. The diffraction pattern includes four groups of light dots in which each group of light dots includes four light dots. The center light dot in each group corresponds to the region of the metasurface configured for a (0°,0°) steering beam. The light dot at (90°,a) in each group corresponds to the region of the metasurface configured for a (90°,a). The light dot at (270°,a) in each group corresponds to the region of the metasurface configured for a (270°,a). The light dot at (0°,a) in each group corresponds to the region of the metasurface configured for a (0°,a). FIG. 6C indicates that 0°≤θ<360°, and diffraction light dots may be created anywhere on a projection plane according to the subject matter disclosed herein.

FIG. 6D relates to an example DOE 600″′ that is configured for beam steering according ot the subject matter disclosed herein. The top image of FIG. 6D indicates that the DOE 600″′ generates a 2×2 diffraction pattern. The middle image of FIG. 6D indicates that the metasurface of the DOE 600″′ is configured into four regions, each having a different fill shade ranging from white to a relatively dark gray. The white metasurface region has been configured for a polar angle θ=0° and an azimuth angle ϕ=0°. One region (upper left) of the metasurface of the DOE 600″′ may be configured for a polar angle θ=90° and an azimuth angle ϕ=a. Another region (upper right) of the DOE 600″′ may be configured for a polar angle of θ=270° and an azimuth angle ϕ=a. The fourth region (lower right) of the DOE 600″′ may be configured for a polar angle of θ=0° and an azimuth angle ϕ=b.

The bottom image of FIG. 6D depicts an example diffraction pattern that is generated by the DOE 600″′. The diffraction pattern includes four groups of light dots in which each group of light dots includes four light dots. The center light dot in each group corresponds to the region of the metasurface configured for a (0°,0°) steering beam. The light dot at (90°,a) in each group corresponds to the region of the metasurface configured for a (90°,a). The light dot at (270°,a) in each group corresponds to the region of the metasurface configured for a (270°,a). The light dot at (0°,a) in each group corresponds to the region of the metasurface configured for a (0°,b). FIG. 6D indicates that 0°≤ϕ≤90° or 0°≤ϕ≤FOV/2 so that adjacent light dots do not overlap, thereby avoiding interference between different diffraction orders.

FIGS. 5A-5C and FIGS. 6A-6D together show that DOEs disclosed herein may provide dynamic beam steering. That is, different cell regions of a metasurface may be configured for different steering angles (θ₁, . . . , θ_{N}, ϕ₁, . . . , ϕ_{N}) and each of the different cell regions of the metasurface may be selectively turned on or off, resulting in a diffraction pattern that may dynamically change as designed by a user.

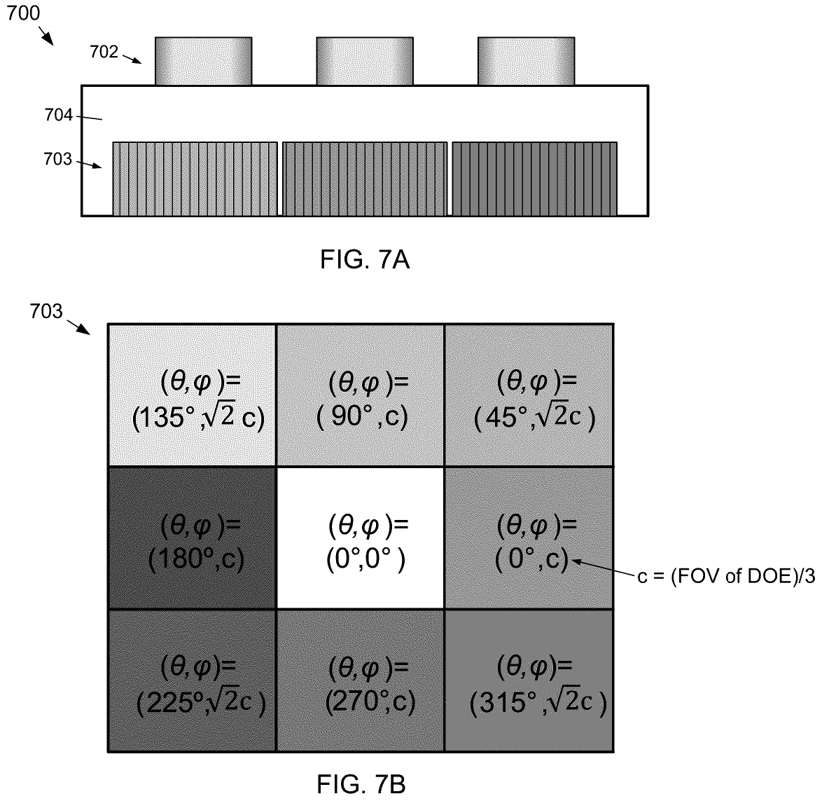

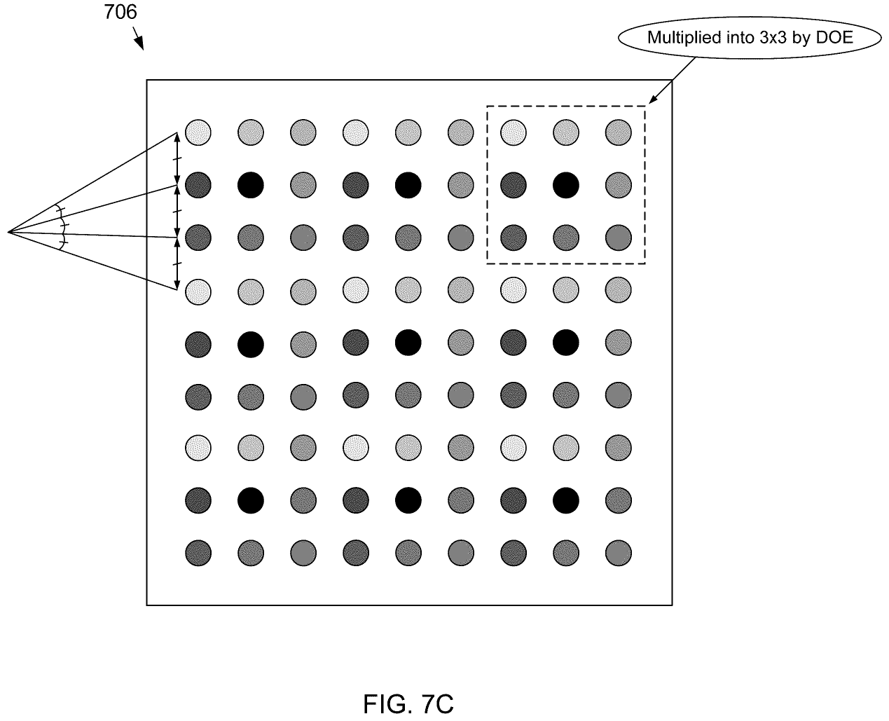

FIG. 7A depicts a cross-sectional side view of a DOE 700 that includes a metasurface that generates seamless tiling patterns for fan-out without using a VCSEL array according to the subject matter disclosed herein. FIG. 7B depicts polar and azimumth angles configured for different cell regions of a metasurface of the DOE 700 according to the subject matter disclosed herein. FIG. 7C depicts an example diffraction pattern 706 generated by the DOE 700 of FIG. 7A. DOE 700 may include a substrate layer (not shown), a DOE layer 702, and a metasurface layer 703. An encapulation layer 704 may be formed between the DOE layer 702 and the metasurface layer 703. FIG. 7B depicts how the metasurface 703 has been arranged into nine cell regions in which each cell region has a different polar and azimuth steering angles.

When diagonal diffraction dots are created at ϕ=\sqrt{2c}, the metasurface 703 creates square patterns of dots that are replicated in a 3×3 arrangement by the DOE 700. When vertical/horizontal ϕ=(FOV of DOE)/3 and diagonal ϕ=\sqrt{2}×(FOV of DOE)/3, seamless tiling of a square dot pattern may be achieved. The three angles depicted toward the upper left of FIG. 7C represent angles that are equal in order to generate a perfectly tiled optical pattern. For the example depicted in FIG. 7C, each angle is ⅙ of the FOV of the DOE.

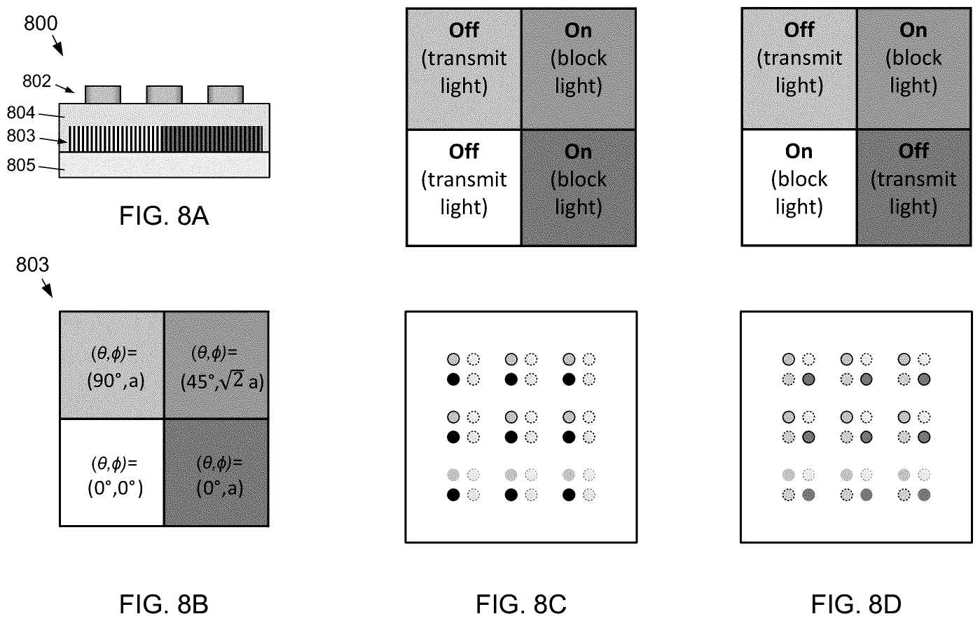

FIG. 8A depicts a cross-sectional side view of a DOE 800 that generates dynamic optical patterns according to the subject matter disclosed herein. DOE 800 may include a transparent conductive material layer 805 that is formed as a separate layer, a DOE layer 802, and a metasurface layer 803. An encapulation layer 804 may be formed between the DOE layer 802 and the metasurface layer 803. FIG. 8B depicts how the metasurface 803 has been arranged into four cell regions in which each cell region has a different polar and azimuth steering angles. In one embodiment, the transparent conductive material layer 805 may be, for example, ITO, in which an electrical input controls whether light is transmitted or is blocked. When a region of the ITO material is “on”, the ITO material blocks light and turns of the light dots. In contrast to a VCSEL arrays in which each column of dots is controlled together, a DOE disclosed herein is capable of selectively switching each dot on and off (or a region of dots on and off), thereby providing highly variable and diverse optical patterns in which individual dots may be controlled at a certain locations at certain times to obtain more useful information.

The top image in FIG. 8C depicts an example in which the two right-most cell regions of the metasurface 803 are controlled to turn off light dots contributed to the diffraction pattern by the two cell regions. The bottom image in FIG. 8C shows an example 4×4 diffraction pattern generated by the DOE 800 when the two right-most cell regions of the metasurface are controlled to turn off dots. Dots that are turned off are represented by dashed outlines.

The top image in FIG. 8D depicts another example in which two diagonal cell regions (lower left and upper right) of the metasurface 803 are controlled to turn off light dots contributed to the diffraction pattern by the two “off” cell regions. The bottom image in FIG. 8D shows an example 4×4 diffraction pattern generated by the DOE 800 when the two diagonal cell regions of the metasurface are controlled to turn off dots. Again,dots that are turned off are represented by dashed outlines.

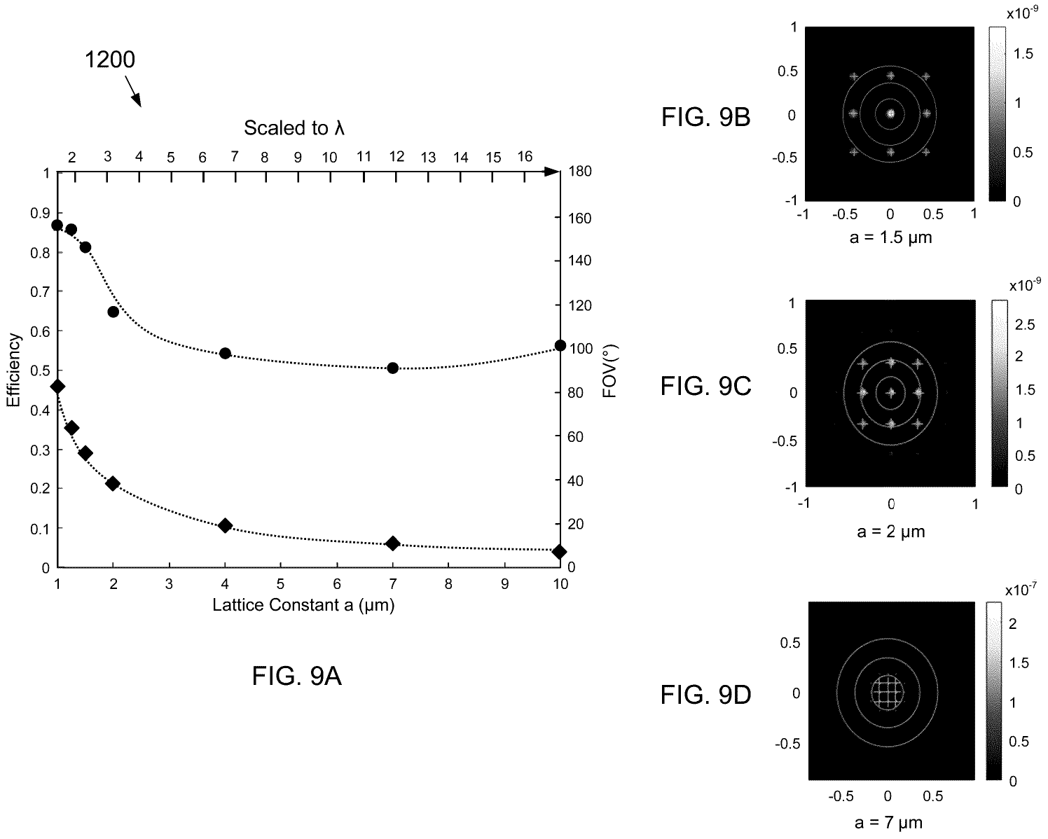

FIG. 9A is a graph 900 of transmission efficiency and of field of view (FOV) as a function of lattice constant scaled to λ according to the subject matter disclosed herein. Curve 901 in graph 900 represents transmission efficiency as a function of lattice constant a, and curve 902 represents FOV as a function of lattice constant a. The transmission efficiency for curve 901 has been calculated only for a 3×3 region of a diffraction pattern.

FIGS. 9B-9D are example diffraction patterns for different lattice constants according to the subject matter disclosed herein. The horizontal and vertical numbering for cach of FIGS. 9B-9D are arbitary units, as are the intensity units. Each circle in the diffraction patterns represents a 10° diffraction. FIG. 9B shows a diffraction pattern for a DOE having a lattice constant a 1.5 μm. FIG. 9C shows a diffraction pattern for a DOE having a lattice constant of 2 μm. FIG. 9D shows a diffraction pattern for a DOE having a lattice constant of 7 μm.

As shown in graph 900 and the diffraction patterns of FIGS. 9B-9D, as the lattice constant a increases, transmission efficiency tends to be reduced. Additionally, as the lattice constant a increases, the light dots of the diffraction pattern are produced within a smaller angle. That is, the FOV becomes smaller as the lattice constant a increases. Additionally, the light dots produced with a larger lattice constant have a smaller Full Width at Half Maximum (FWHM) and a higher intensity.

One example embodiment of a DOE having a substrate and pillars formed from SiO₂, a pillar eight of 712 nm and a lattice constant that is less that 1.5 μm provides a transmission efficiency greater than 82% and a FOV that is greater than 57° at a target wavelength of 650 nm. These performance values are confirmed by the graph 900 in FIG. 9A.

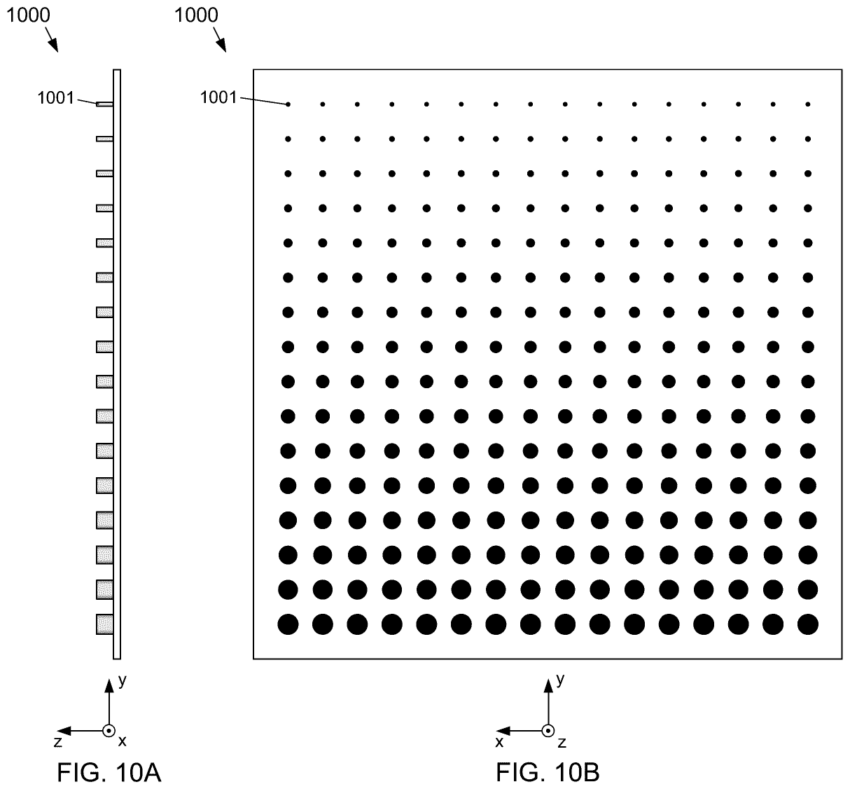

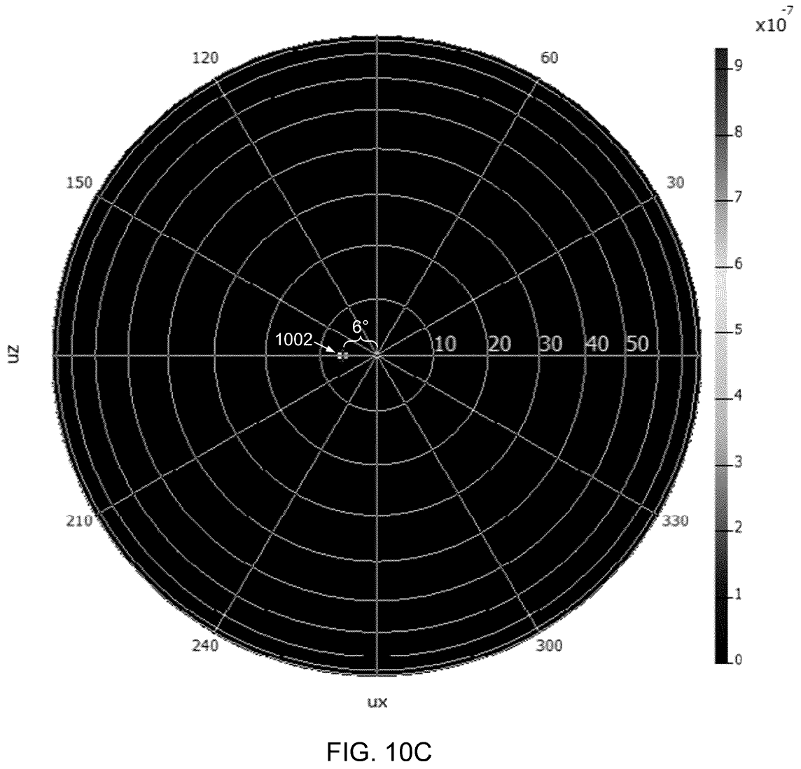

FIGS. 10A and 10B respectively depict a sideview and a plan view of an example metasurface cell 1000 that is configured to provide a beam steering angle of 6° at a target wavelength of 905 nm according to the subject matter disclosed herein. (Note that FIGS. 10A and 10B are not drawn to scale.) Creating a 2π phase shift within a period of a lattice constant enables beam steering. A smaller period results in a wider angle of beam steering. The metasurface 1000 includes pillars 1001 formed from amorphous silicon (aSi) that range in size (diameter) from 60 nm to 240 nm, and have a pillar height of 600 nm and an aspect ratio of less than 1:10. The lattice constant is 340 nm. The pixel size for DOE layer pillars (not shown) to generate a 4×4 diffraction pattern is 1.36 μm. FIG. 10C is an example diffraction pattern that is generated by the metasurface 1000. The light dot at 1002 corresponds to a beam steering angle of 6°. The units for intensity shown in FIG. 10C are relative, arbitrary units (a.u.) and the strongest peak intensity may be set to 1. Each circle in plots of light intensity diffraction pattern in FIGS. 10C represents a 10° increment of diffraction.

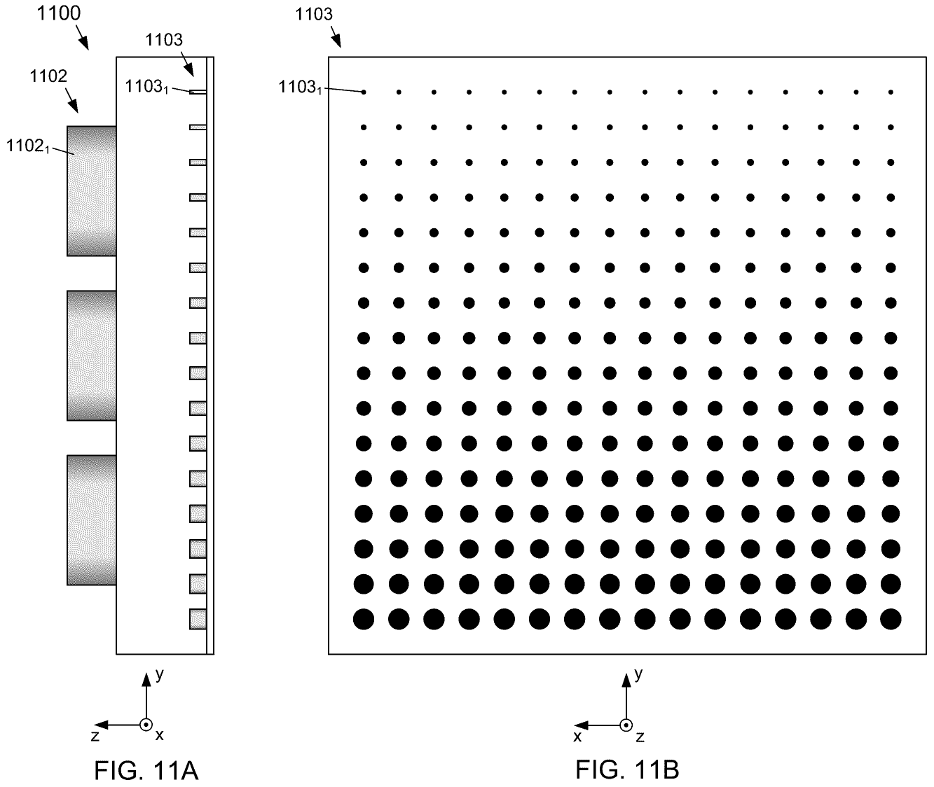

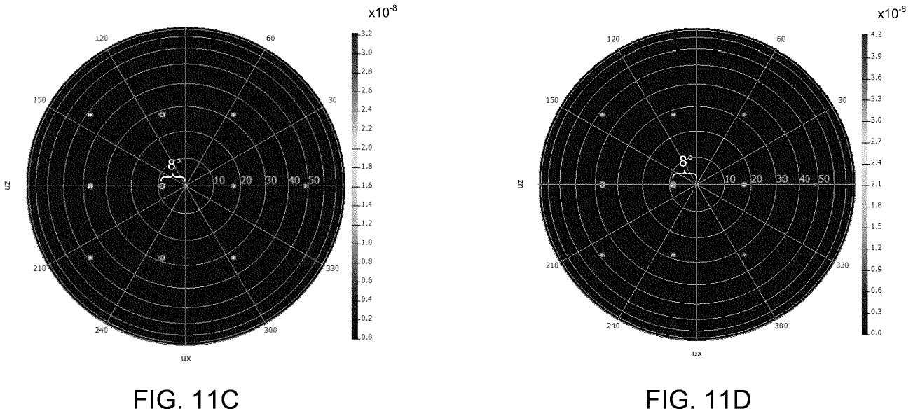

FIG. 11A depicts a sideview of an example DOA 1100 that is configured to provide a 3×3 light dot pattern having a beam steering angle of 8° at a target wavelength of 905 nm according to the subject matter disclosed herein. The DOA 1100 includes a DOA layer 1102 and a metasurface layer 1103. FIG. 11B depicts a top view of the metasurface layer 1103 that is configured to provide the beam steering angle of 8° at the target wavelength of 905 nm according to the subject matter disclosed herein. (Note that FIGS. 11A and 11B are not drawn to scale.) The metasurface 1103 includes pillars 1103₁ formed from amorphous silicon (aSi) that range in size (diameter) from 60 nm to 240 nm, and have a pillar height of 600 nm, an aspect ratio of less than 1:10, and a gap size between the nanostructure layer and the pillar layer of 5 μm. The lattice constant is 340 nm. The pixel size for DOE layer pillars 1102₁ to generate a 3×3 diffraction pattern is 1.20 μm.

FIGS. 11C and 11D respectively are 3×3 transverse electric (TE) mode and transverse magnetic (TM) mode light diffraction patterns for the example DOE 1100. The 3×3 diffraction light patterns show a steering angle of 8°, as indicated at 1104. The units for intensity shown in FIGS. 11C and 11D are relative, arbitrary units (a.u.) and the strongest peak intensity may be set to 1. Each circle in plots of light intensity diffraction pattern in FIGS. 11C and 11D represents a 10° increment of diffraction.

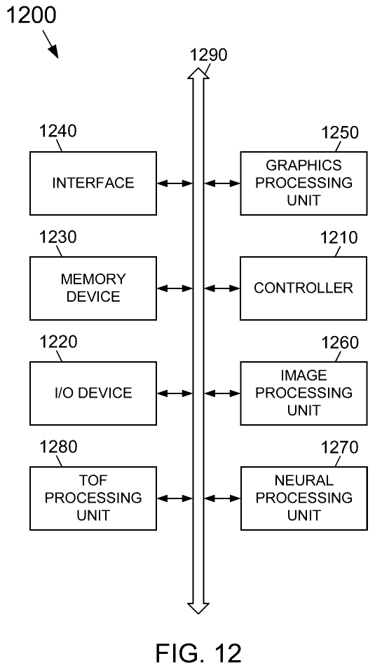

FIG. 12 depicts an electronic device 1200 that may include a DOE capable of beam steering and/or dynamic diffraction pattern generation according to the subject matter disclosed herein. Electronic device 1200 and the various system components of electronic device 1200 may be formed from one or modules. The electronic device 1200 may include a controller (or CPU) 1210, an input/output device 1220 such as, but not limited to, a keypad, a keyboard, a display, a touch-screen display, a 2D image sensor, a 3D image sensor, a memory 1230, an interface 1240, a GPU 1250, an imaging-processing unit 1260, a neural processing unit 1270, a TOF processing unit 1280 that are coupled to each other through a bus 1290. In one embodiment, the electronic device 1200 may include a DOE capable of beam steering and/or dynamic diffraction pattern generation according to the subject matter disclosed herein that may be part of image processing unit 1260 and/or may be part of the TOF processing unit. In one embodiment, the 2D image sensor and/or the 3D image sensor may be part of the imaging processing unit 1260. In another embodiment, the 3D image sensor may be part of the TOF processing unit 1280. The controller 1210 may include, for example, at least one microprocessor, at least one digital signal processor, at least one microcontroller, or the like. The memory 1230 may be configured to store command codes that are to be used by the controller 1210 and/or to store a user data.

The interface 1240 may be configured to include a wireless interface that is configured to transmit data to or receive data from, for example, a wireless communication network using a RF signal. The wireless interface 1240 may include, for example, an antenna. The electronic system 1200 also may be used in a communication interface protocol of a communication system, such as, but not limited to, Code Division Multiple Access (CDMA), Global System for Mobile Communications (GSM), North American Digital Communications (NADC), Extended Time Division Multiple Access (E-TDMA), Wideband CDMA (WCDMA), CDMA2000, Wi-Fi, Municipal Wi-Fi (Muni Wi-Fi), Bluetooth, Digital Enhanced Cordless Telecommunications (DECT), Wireless Universal Serial Bus (Wireless USB), Fast low-latency access with seamless handoff Orthogonal Frequency Division Multiplexing (Flash-OFDM), IEEE 802.20, General Packet Radio Service (GPRS), iBurst, Wireless Broadband (WiBro), WiMAX, WiMAX-Advanced, Universal Mobile Telecommunication Service-Time Division Duplex (UMTS-TDD), High Speed Packet Access (HSPA), Evolution Data Optimized (EVDO), Long Term Evolution-Advanced (LTE-Advanced), Multichannel Multipoint Distribution Service (MMDS), Fifth-Generation Wireless (5G), Sixth-Generation Wireless (6G), and so forth.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A diffractive optical pattern generator, comprising:
a diffractive optical element (DOE) layer; and
a nanostructure layer configured for beam steering an input light applied to the diffractive optical pattern generator to at least one of a predetermined polar beam-steering angle that is measured in a plane that is substantially normal to a direction of the input light and a predetermined azimuth beam-steering angle measured with respect to the direction of the input light.

2. The diffractive optical pattern generator of claim 1, wherein the nanostructure layer comprises pillar-shaped nanostructures formed on a surface of a substrate layer, holes formed in the substrate layer, or a combination thereof.

3. The diffractive optical pattern generator of claim 2, the nanostructure layer comprises nanostructures having a predetermined periodicity ranging from 0.75 λ to 3 λ of a target wavelength λ.

4. The diffractive optical pattern generator of claim 1, further comprising a dynamic transmission layer comprising at least one region of the dynamic transmission layer that is selectively controllable to transmit light through or to block light from passing through the dynamic transmission layer.

5. The diffractive optical pattern generator of claim 4, wherein the dynamic transmission layer comprises at least one of indium-tin oxide, a liquid-crystal material, a phase-changing material, an organic metal, and a semiconductor material.

6. The diffractive optical pattern generator of claim 4, wherein the nanostructure layer comprises a first region and a second region, the first region of the nanostructure layer comprising a first predetermined polar beam-steering angle and a first predetermined azimuth beam-steering angle with respect to the input light, and the second region of the nanostructure layer, and
wherein the dynamic transmission layer comprises a first region and a second region that respectively correspond to the first region and the second region of the nanostructure layer, the first region and the second region of the dynamic transmission layer each being selectively controllable to transmit light through or to block light from passing through the first and second regions of the dynamic transmission layer to generate different diffractive optical patterns.

7. The diffractive optical pattern generator of claim 1, wherein the nanostructure layer is configured to beam steer light input to the DOE layer or beam steer light output from the DOE layer.

8. The diffractive optical pattern generator of claim 1, wherein the DOE layer generates a n×n diffraction pattern in which n comprises an integer greater than 0, and
wherein the nanostructure layer comprises a n×n arrangement of cell regions, each cell region comprising at least one of a corresponding polar beam-steering angle and a corresponding azimuth beam-steering angle.

9. The diffractive optical pattern generator of claim 8, wherein n=3, and
wherein the 3×3 arrangement of cell regions comprise a center cell region, four corner cell regions, and four edge cell regions, each edge cell region being located between a corner edge region, each edge cell region comprising an azimuth beam-steering angle equal to one c=⅓ (field of view of the DOE layer), and each corner cell region comprising an azimuth beam-steering angle equal to \sqrt{2}c.

10. A diffractive optical pattern generator, comprising:
a diffractive optical element (DOE) layer;
a nanostructure layer configured to collimate light or diffuse light; and
a dynamic transmission layer comprising at least one region of the dynamic transmission layer that is selectively controllable to transmit light through or to block light from passing through the dynamic transmission layer.

11. The diffractive optical pattern generator of claim 10, wherein the nanostructure layer comprises pillar-shaped nanostructures formed on a surface of a substrate layer, holes formed in the substrate layer, or a combination thereof.

12. The diffractive optical pattern generator of claim 11, wherein the nanostructure layer is configured for beam steering an input light applied to the diffractive optical pattern generator to at least one of a predetermined polar beam-steering angle that is measured in a plane that is substantially normal to a direction of the input light and a predetermined azimuth beam-steering angle measured with respect to the direction of the input light.

13. The diffractive optical pattern generator of claim 11, the nanostructure layer comprises nanostructures having a predetermined periodicity ranging from 0.75 λ to 3 λ of a target wavelength λ.

14. The diffractive optical pattern generator of claim 10, wherein the dynamic transmission layer comprises at least one of indium-tin oxide, a liquid-crystal material, a phase-changing material, an organic metal, and a semiconductor material.

15. The diffractive optical pattern generator of claim 10, wherein the nanostructure layer comprises a first region and a second region, the first region of the nanostructure layer comprising a first predetermined polar beam-steering angle and a first predetermined azimuth beam-steering angle with respect to an input light, and the second region of the nanostructure layer, and
wherein the dynamic transmission layer comprises a first region and a second region that respectively correspond to the first region and the second region of the nanostructure layer, the first region and the second region of the dynamic transmission layer each being selectively controllable to transmit light through or to block light from passing through the first and second regions of the dynamic transmission layer to generate different diffractive optical patterns.

16. The diffractive optical pattern generator of claim 10, wherein the DOE layer generates a n×n diffraction pattern in which n comprises an integer greater than 0, and
wherein the nanostructure layer comprises a n×n arrangement of cell regions, each cell region comprising at least one of a corresponding polar beam-steering angle and a corresponding azimuth beam-steering angle.

17. The diffractive optical pattern generator of claim 16, wherein n=3, and
wherein the 3×3 arrangement of cell regions comprise a center cell region, four corner cell regions, and four edge cell regions, each edge cell region being located between a corner edge region, each edge cell region comprising an azimuth beam-steering angle equal to one c=⅓ (field of view of the DOE layer), and each corner cell region comprising an azimuth beam-steering angle equal to \sqrt{2}c.

18. A diffractive optical pattern generator, comprising:
a diffractive optical element (DOE) layer that generates a n×n diffraction pattern in which n comprises an integer greater than 0;
a nanostructure layer comprising a n×n arrangement of cell regions, each cell region comprising at least one of a corresponding polar beam-steering angle that is measured in a plane that is substantially normal to a direction of the input light and a corresponding azimuth beam-steering angle measured with respect to the direction of the input light; and
a dynamic transmission layer comprising at least one region of the dynamic transmission layer that is selectively controllable to transmit light through or to block light from passing through the dynamic transmission layer.

19. The diffractive optical pattern generator of claim 18, wherein n=3, and
wherein the 3×3 arrangement of cell regions comprise a center cell region, four corner cell regions, and four edge cell regions, each edge cell region being located between a corner edge region, each edge cell region comprising an azimuth beam-steering angle equal to one c=⅓ (field of view of the DOE layer), and each corner cell region comprising an azimuth beam-steering angle equal to \sqrt{2}c.

20. The diffractive optical pattern generator of claim 18, wherein the nanostructure layer is configured for beam steering an input light applied to the diffractive optical pattern generator to at least one of a predetermined polar beam-steering angle with respect to the input light and a predetermined azimuth beam-steering angle with respect to the input light,
the nanostructure layer comprises nanostructures having a predetermined periodicity ranging from 0.75 λ to 3 λ of a target wavelength λ, and
wherein the nanostructure layer is configured to beam steer light input to the DOE layer or beam steer light output from the DOE layer.
